(19) United States
(12) Patent Application Publication
(10) Pub. No.: US 2007/0164170 A1
(43) Pub. Date: Jul. 19, 2007

(54) MOUNTING APPARATUS FOR STORAGE DEVICE

(75) Inventors: Ri-Dong Huang, Shenzhen (CN); Hsuan-Tsung Chen, Tu-Cheng (TW); Guang-Yao Lee, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,764

(22) Filed: Sep. 22, 2006

(30) Foreign Application Priority Data
Jan. 18, 2006 (CN) 200620054304.7

(51) Int. Cl. G12B 9/00

(52) U.S. Cl. 248/27.1

(57) ABSTRACT

A mounting apparatus includes a bracket for receiving a storage device, two latching members pivotally fixed to the bracket, and an elastic member connected with the latching members. The bracket includes a sidewall defining two through holes therein, and each of the latching members includes a latching protrusion to extend through a corresponding through hole of the bracket for fixing the storage device. The elastic member connects the latching members and allows one of the latching members to simultaneously move whilst the other of the latching members is manipulated.

### FIELD OF THE INVENTION

The present invention relates to mounting apparatuses, and more particularly to a mounting apparatus for a storage device.

### DESCRIPTION OF RELATED ART

An electronic apparatus, such as a typical desktop computer, a tower computer, a server, and the like, usually includes storage devices, such as hard disk drives, compact disk read-only memory (CD-ROM) drives, digital video disc (DVD) drives, floppy disk drives, and the like. These devices are typically added to increase the functionality of the electronic apparatus as desired by a user. However, the installation of such devices in the electronic apparatus is always labor-intensive.

The installation of a hard disk drive in a computer typically involves the use of screws to attach the hard disk drive to a bracket of a computer chassis. However, these screws are usually too small and difficult to handle. Additionally, because of their small size, the screws are easily dropped, by an assembler, into the computer.

To address the aforementioned problems, a plurality of mounting apparatuses is invented to reduce the number of needed screws. For example, a pair of detachable rails is attached to opposite sides of a storage device with screws. The storage device is then slid into and secured to a drive bracket. However, the screws have to be removed to detach the rails from the storage device before replacing the storage device.

What is needed, therefore, is a mounting apparatus which facilitates convenient and secure mounting of a storage device in a bracket.

### SUMMARY OF THE INVENTION

An exemplary mounting apparatus includes a bracket for receiving a storage device, two latching members pivotally fixed to the bracket, and an elastic member connected with the latching members. The bracket includes a sidewall defining two through holes therein, and each of the latching members includes a latching protrusion to extend through a corresponding through hole of the bracket for fixing the storage device. The elastic member connects the latching members and allows one of the latching members to simultaneously move whilst the other of the latching members is manipulated.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an exploded, isometric view of a mounting apparatus with a storage device in accordance with a preferred embodiment of the present invention, the mounting apparatus including a bracket, two latching members, two pressing members, and an elastic member;

FIG. 2 an enlarged isometric view of the latch members, the pressing members, and the elastic member of FIG. 1, but viewed from another aspect;

FIG. 3 is an assembled view of FIG. 1; and

FIG. 4 is similar to FIG. 3, but showing another state of the mounting apparatus.

### DETAILED DESCRIPTION OF THE INVENTION

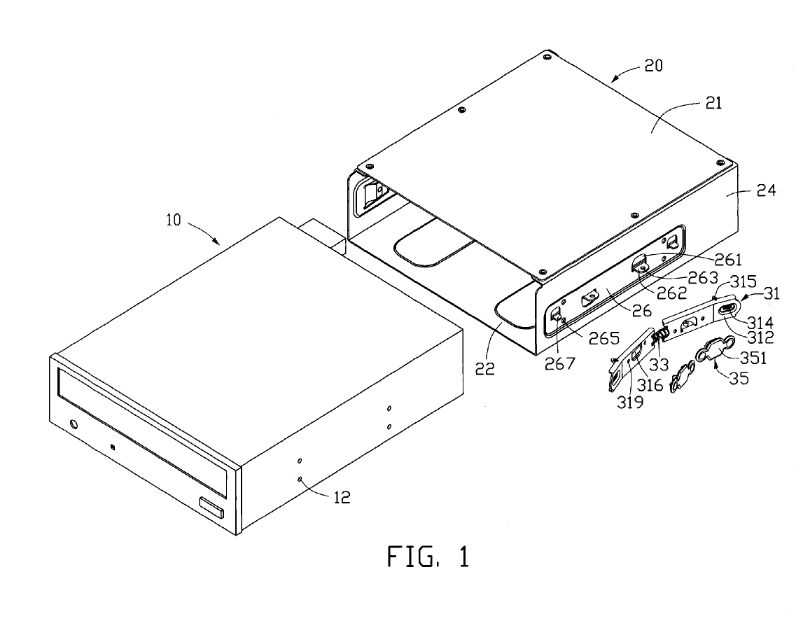

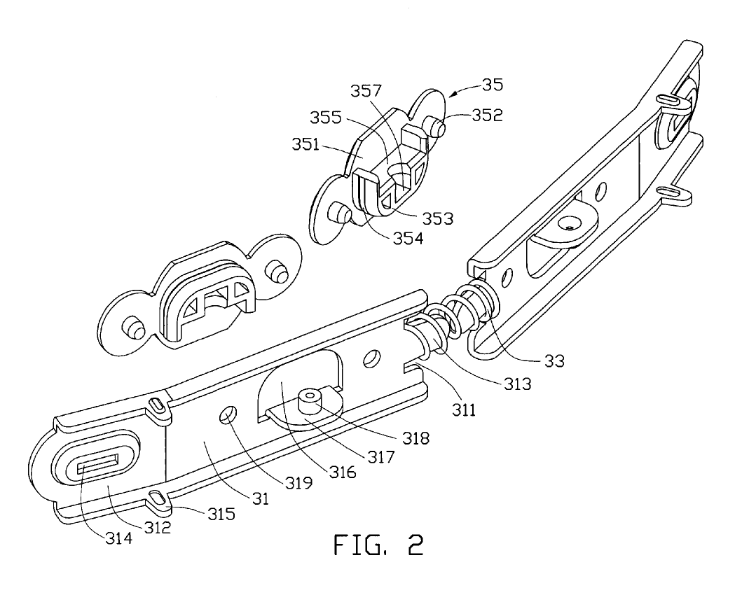

Referring to FIGS. 1 and 2, a mounting apparatus for a storage device is provided in accordance with a preferred embodiment of the present invention. The mounting apparatus includes a bracket 20 for fixing a storage device 10 defining two pairs of spaced fixing holes 12, a pair of latching members 31, a pair of pressing members 35, and an elastic member 33 for connecting the latching members 31. In this embodiment, the elastic member 33 is a spring.

The bracket 20 includes a top wall 21, a bottom wall 22, and a pair sidewalls 24 connecting the top wall 21 and the bottom wall 22. One of the sidewalls 24 includes a concave portion 26. Two fixing tabs 267 are punched outwardly from the concave portion 26 adjacent to two ends of the concave portion 26 respectively. Two pairs of through holes 265 are defined in the concave portion 26, corresponding to the pairs of fixing holes 12 of the storage device 10. The pairs of through holes 265 are adjacent to the fixing tabs 267 respectively. Two spaced openings 261 are defined in a middle section of the concave portion 26. A support tab 262 protrudes outwardly from the concave portion 26 above one opening 261, and another support tab 262 protrudes outwardly from the concave portion 26 below the other opening 261. Each of the support tabs 262 defines an aperture 263 therein.

Referring particularly to FIG. 2, each latching member 31 defines two spaced through holes 319 therein, and an opening 316 is defined in the latching member 31 between the through holes 319. A pivot portion 317 extends perpendicularly inward from each latching member 31 adjoining the opening 316, corresponding to the support tab 262 of the bracket 20. A pivot 318 protrudes from each pivot portion 317. One end of each latching member 31 defines a notch 311, and a rod 313 protrudes out from a surface bounding a bottom of the notch 311 of the latching member 31. The other end of each latching member 31 forms a securing portion 312 slanted outwardly. A slot 314 is defined in the securing portion 312 of each latching member 31 corresponding to the fixing tabs 267 of the bracket 20. Two latching protrusions 315 extend perpendicularly inward from two sidewalls of each securing portion 312.

Each pressing member 35 includes a pressing portion 351. Two spaced projections 352 are formed on a side of each pressing portion 351, corresponding to the through holes 319 of the latching member 31, and a block 353 extends from the side of the pressing portion 351 between the projections 352. A flange 354 is formed around an external surface of each block 353 spaced apart from the pressing portion 351, and a generally U-shaped groove 355 is defined in an upper portion of the block 353 for receiving the pivot portion 317 of the corresponding latching member 31. A latching notch 357 is defined in a lower portion of each block 353 in communication with the groove 355, for receiving the pivot 318 of the corresponding latching member 31.

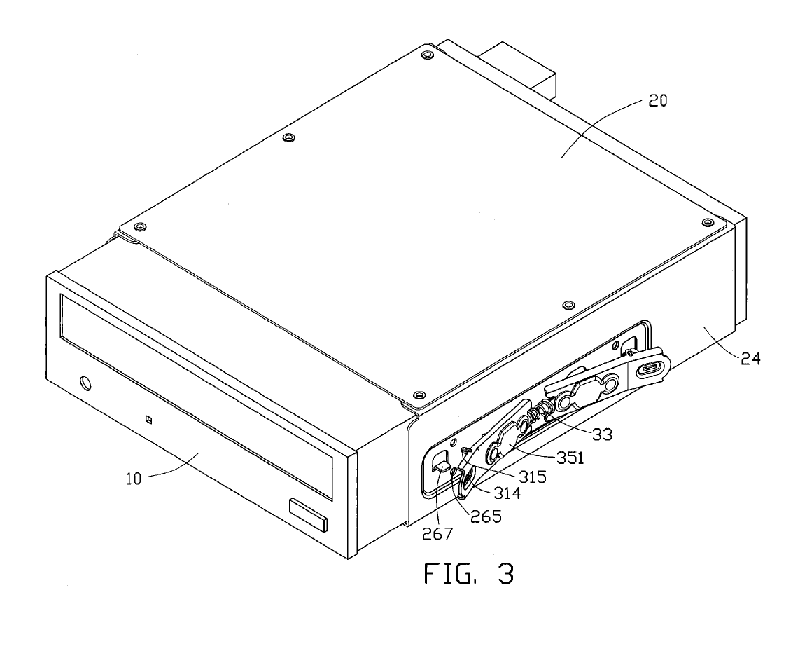

Referring also to FIG. 3, in assembly, two ends of the elastic member 33 are placed around the rods 313 of the latching members 31 respectively, and the elastic member 33 connect the latching members 31 together. The pivots 318 on the pivot portions 317 of the latching members 31 are extended through the apertures 263 of the support tabs 262 of the bracket 20 respectively. The blocks 353 of the pressing members 35 are extended through the openings 316 of the latching members 31 respectively, and the projections 352 of the pressing members 35 engage in the through holes 319 of the latching members 31 respectively. The support tabs 262 of the bracket 20 and the pivot portions 317 of the latching members 31 are received in the grooves 355 of the blocks 353 of the pressing members 35 respectively, thereby sandwiching the support tabs 262 between the pivot portions 317 and the blocks 353. The pivots 318 of the latching members 31 are received in the latching notches 357 of the corresponding pressing members 35. The flanges 354 on the blocks 353 of the pressing members 35 are received in the corresponding openings 316 and snappingly engage with surfaces of the latching members 31 defining the openings 316. The pressing members 35 are thus fixed to the latching members 31 respectively, and the latching members 31 are pivotally mounted on the bracket 20. The ends of the latching members 31, which are connected by the elastic member 33, are proximal to the sidewall 24 of the bracket 20, the elastic member 33 is slightly compressed and is held in a relatively steady state, and the securing portions 312 of the latching members 31 are positioned away from the sidewall 24.

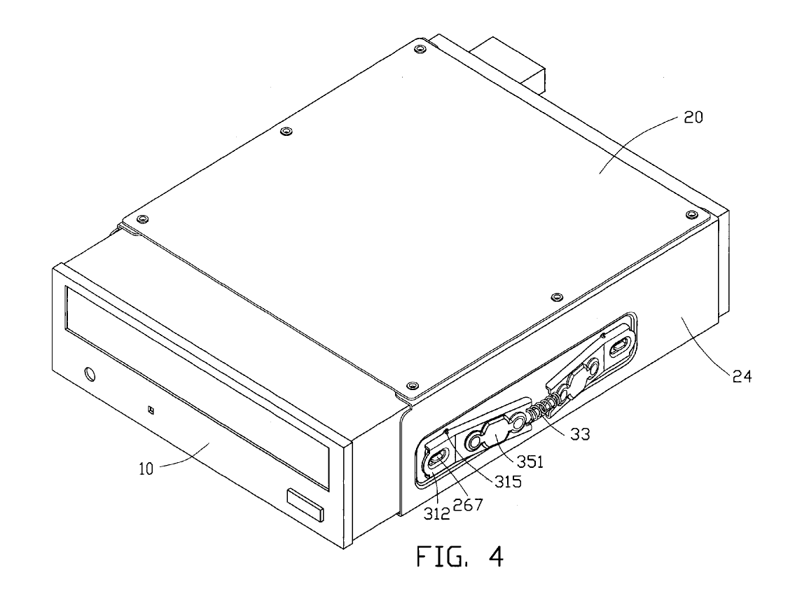

In use, the storage device 10 is installed into the bracket 20. When the fixing holes 12 of the storage device 10 align with the through holes 265 in the sidewall 24 of the bracket 20 respectively, the securing portion 312 of one of the latching members 31 is pushed toward the sidewall 24 of the bracket 20. The end of the one of the latching members 31 opposite to the securing portion 312 is rotated away from the sidewall 24 of the bracket 20 around the pivot 318 thereof. The elastic member 33 is bent outwardly to drive the other of the latching members 31 to rotate. The latching protrusions 315 of the latching members 31 are extended through the through holes 265 of the bracket 20 and engage in the fixing holes 12 of the storage device 10 respectively, the elastic member 33 is slightly compressed, and the fixing tabs 267 of the bracket 20 engage in the slots 314 of the latching members 31 respectively, for helping holding the latching members 31. The elastic member 33 and the latching members 31 cooperatively form a relatively steady system. The storage device 10 is thus fixed to the bracket 20, as shown in FIG. 4.

To detach the storage device 10 from the bracket 20, the pressing portion 351 of one of the pressing members 35 is pressed, the latching member 31 connected with the one of the pressing members 35 is rotated, the elastic member 33 is restored to drive the other of the latching members 31 to rotate in an opposite direction. The slots 314 of the latching members 31 disengage from the corresponding fixing tabs 267 of the bracket 20, and the latching protrusions 315 of the latching members 31 are disengaged from the fixing holes 12 of the storage device 10 and withdrawn from the through holes 265 of the bracket 20 respectively as shown in FIG. 3. The storage device 10 is ready to be detached from the bracket 20.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A mounting apparatus for a storage device, the mounting apparatus comprising:
a bracket configured for receiving the storage device, the bracket comprising a sidewall defining two through holes therein;
two latching members pivotally fixed to the bracket, each of the latching members comprising a latching protrusion to extend through a corresponding through hole of the bracket for fixing the storage device; and
an elastic member connecting the latching members in a manner so as to allow one of the latching members to simultaneously move whilst the other of the latching members is manipulated.

2. The mounting apparatus as claimed in claim 1, wherein two fixing tabs are formed on the bracket, each of the latching members forms a securing portion slanted outwardly to engage in a corresponding fixing tab of the bracket.

3. The mounting apparatus as claimed in claim 1, wherein two support tabs protrude outwardly from the bracket, each of the support tabs defines an aperture, each of the latching members forms a pivot portion, and a pivot formed on the pivot portion is rotatably extended through the aperture of a corresponding support tab.

4. The mounting apparatus as claimed in claim 3, further comprising two pressing members, each of the pressing members comprising a block defining a groove therein, each of the latching members defining an opening, the block extended through the corresponding opening, and the groove receiving the corresponding support tab of the bracket and the pivot portion of a corresponding latching member.

5. The mounting apparatus as claimed in claim 4, wherein each of the pressing members comprises a pressing portion connected with the block, each of the latching members defines a through hole, and the pressing portion forms a projection engaging in the corresponding through hole.

6. The mounting apparatus as claimed in claim 4, wherein the block forms a flange for engaging with an inside surface of the corresponding latching member.

7. The mounting apparatus as claimed in claim 1, wherein a rod protrudes from an end of each of the latching members, and two ends of the elastic member are placed around the rods of the latching members respectively.

8. A mounting apparatus for a storage device, the mounting apparatus comprising:
a bracket configured for receiving the storage device, the bracket comprising a sidewall defining two through holes therein; and
two connected latching members pivotally fixed to the bracket, each of the latching members comprising a securing portion slanted outwardly, a latching protrusion formed on the securing portion to extend through a corresponding through hole of the bracket for engaging the storage device.

9. The mounting apparatus as claimed in claim 8, wherein two fixing tabs are formed on the bracket to engage with the securing portions of the latching members respectively.

10. The mounting apparatus as claimed in claim 8, further comprising an elastic member connecting the latching members together.

11. The mounting apparatus as claimed in claim 8, wherein two support tabs protrude outwardly from the bracket, each of the support tabs defines an aperture, each of the latching members forms a pivot portion, and a pivot formed on the pivot portion is rotatably extended through the aperture of a corresponding support tab.

12. The mounting apparatus as claimed in claim 11, further comprising two pressing members, each of the pressing members comprising a block defining a groove therein, each of the latching members defining an opening, the block extended through the corresponding opening, and the groove receiving the corresponding support tab of the bracket and the pivot portion of a corresponding latching member.

13. The mounting apparatus as claimed in claim 12, wherein each of the pressing members comprises a pressing portion connected with the block, each of the latching members defines a through hole, and the pressing portion forms a projection engaging in the corresponding through hole.

14. The mounting apparatus as claimed in claim 12, wherein the block forms a flange for engaging with an inside surface of the corresponding latching member.

15. A storage device assembly comprising:
a bracket defining a receiving cavity therein and including a bracket wall;
a storage device removably received in the receiving cavity and defining a pair of mounting holes therein; and
a pair of latching members pivotably attached to the bracket wall, each of the latching members including a latch protrusion, and being pivotable between a locked position and an unlocked position, the locked position being where the latch protrusion extends through the bracket wall into a corresponding one of the mounting holes so as to latch the storage device in the bracket, the unlocked position being where the latch protrusion disengages from the corresponding one of the mounting holes, the latching members being interconnected in such a manner that upon pivoting of one of the latching members, the other of the latching members is driven to pivot by the one of the latching members.

16. The storage device assembly of claim 15, wherein the latching members are interconnected by an elastic member biased between opposed end portions of the latching members.

17. The storage device assembly of claim 15, wherein pivot axes of the latching members are parallel to the bracket wall.
